(19) United States
(12) Patent Application Publication
(10) Pub. No.: US 2014/0305919 A1
(43) Pub. Date: Oct. 16, 2014

(54) UNIT FOR HEAT TREATING CONTAINER PREFORMS WITH DOUBLE WALLS RADIATING IN A STAGGERED CONFIGURATION

(71) Applicant: SIDEL PARTICIPATIONS, Octeville Sur Mer (FR)

(72) Inventors: Caroline Bellec, Octeville Sur Mer (FR); Guy Feuilloley, Octeville Sur Mer (FR); Isabelle Maillot, Octeville Sur Mer (FR)

(73) Assignee: SIDEL PARTICIPATIONS, Octeville Sur Mer (FR)

(21) Appl. No.: 14/359,538

(22) PCT Filed: Nov. 20, 2012
(86) PCT No.: PCT/FR2012/052673

§ 371 Date: May 20, 2014

(30) Foreign Application Priority Data
Nov. 21, 2011 (FR) 1160594

(51) Int. Cl. B23K 26/00

(52) U.S. Cl. CPC B23K 26/0066
USPC 219/121.86; 392/416

(57) ABSTRACT

Unit for treating blanks of hollow bodies made of plastic material, including an enclosure having two opposite walls, namely a first wall and a second wall facing the first one, which together define an enclosure through which the blanks pass along a predetermined longitudinal trajectory. Each wall includes a series of spaced emitters each having a plurality of sources of monochromatic or pseudo-monochromatic electromagnetic radiation sources; a reflective section extends into each space between two adjacent emitters; the emitters of the second wall are offset longitudinally with respect to those of the first wall, so that the emitters of each wall face a reflective section of the opposite wall.

The invention concerns the manufacture of hollow bodies such as containers, by blowing or stretch-blowing blanks of plastic material, the term “blank” designating a preform obtained by injection of a plastic material into a mold, or an intermediate hollow body obtained from a preform having undergone at least a first forming operation and intended to undergo at least a second one.

More specifically, the invention concerns the heat treating of blanks, generally by filing them through a treatment unit commonly called “oven”, equipped with a plurality of sources of electromagnetic radiation in front of which the blanks pass, being driven in rotation around their own axis.

A conventional heating technique consists of using incandescent tubular lamps such as halogen, radiating according to the Planck law over a continuous spectrum.

This technique, extremely widespread, is not without its disadvantages, the principal one being essentially that the electrical energy consumed by the lamps is largely wasted by heat dissipation, since only the infrared part of the spectrum is effectively used in the heating. This is the reason the performance of halogen ovens is very poor. Another disadvantage is the lack of precision of the heating, since the halogen lamps are not directive, even though artifacts (mirrors, shutters) can be employed to attempt to locally concentrate the radiation absorbed by the blanks.

An alternative technology has recently arisen, based on the use of lasers emitting in the infrared range (see French patent applications FR 2 878 185 and FR 2 917 418 in the name of the applicant).

The performance and the properties (particularly optical precision) of the laser sources are far superior to those of halogen sources, and in theory make it possible to achieve a faster and more selective heating of the blanks.

However, the intrinsic qualities alone of the laser sources that are known to date are not sufficient to ensure heating of the blanks with good performance and good homogeneity, and it is therefore essential to work on the architecture of the heating unit.

New configurations of heating units have been proposed, such as for example European patent application EP 2 002 962, which proposes to tilt the directive sources with respect to the tangent to the trajectory of the blanks.

A first objective is to ensure good energy distribution in the treatment enclosure.

A second objective is to improve the performance of a blanks treatment unit.

A third objective is to propose a blanks treatment unit that is compact.

To fulfill at least one of these objectives, a unit is proposed for treating blanks of hollow bodies made of plastic material, comprising an enclosure having two opposite walls, namely a first wall and a second wall facing the first one, which together define an enclosure through which the blanks pass along a predetermined longitudinal trajectory, wherein:
each wall includes a series of spaced emitters each comprising a plurality of sources of monochromatic or pseudo-monochromatic electromagnetic radiation sources;
a reflective section extends into each space between two adjacent emitters;
the emitters of the second wall are offset longitudinally with respect to those of the first wall, so that the emitters of each wall face a reflective section of the opposite wall.

Tests conducted with such a configuration have shown that it enables the desired energy distribution to be obtained in the zone of exposure of the blanks. In particular, when a homogeneous treatment is desired, this configuration makes it possible to obtain a homogeneous power of the radiation in the zone of exposure of the blanks. Furthermore, this configuration is compact and has good energy performance.

The following additional characteristics can be provided, alone or in combination:
the treatment unit comprises means of driving blanks in at least two parallel lines inside the enclosure;
the preforms in two lines are arranged so that they are staggered;
each emitter has a width substantially equal to or greater than that of the reflective section facing it;
each wall comprises a juxtaposition of individual modules, each of which comprises:
   a matrix emitter,
   a slotted reflector framing the emitter;
for a given interval between two adjacent emitters, the emitters of the second wall are offset with respect to those of the first wall by a half-interval increased or decreased by a half-width of reflector, or
for a given interval between two adjacent emitters, the emitters of the second wall are offset with respect to the first wall by a half-interval;
the sources of radiation are lasers, for example VCSEL [Vertical Cavity Surface-Emitting Laser] type laser diodes.

Other objects and advantages of the invention will be seen from the following description of embodiments given by way of example, with reference to the appended drawings in which:

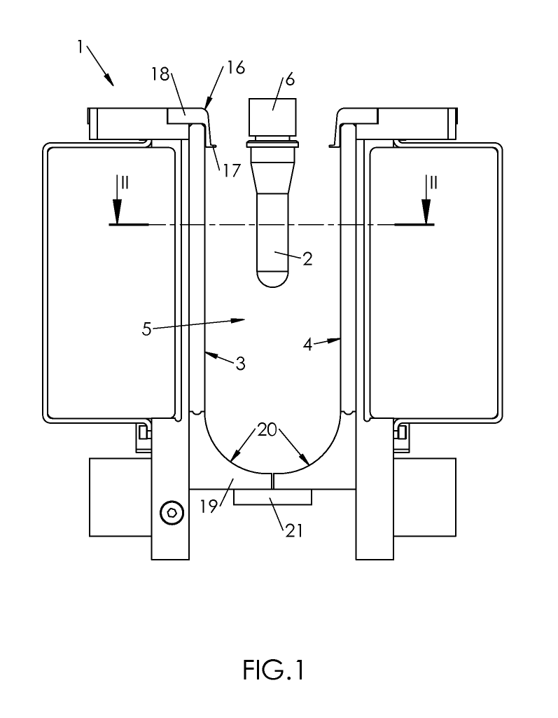

FIG. 1 is a side view showing a unit for heat treating preforms, according to a first embodiment;

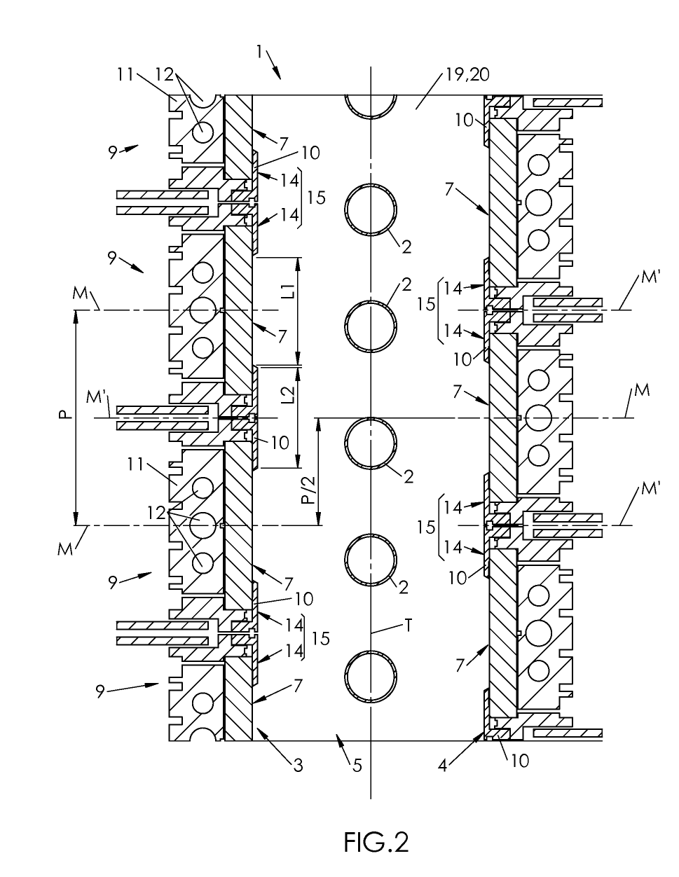

FIG. 2 is a view in horizontal cross-section of the heat treatment unit of FIG. 1, along the cutting plane II-II;

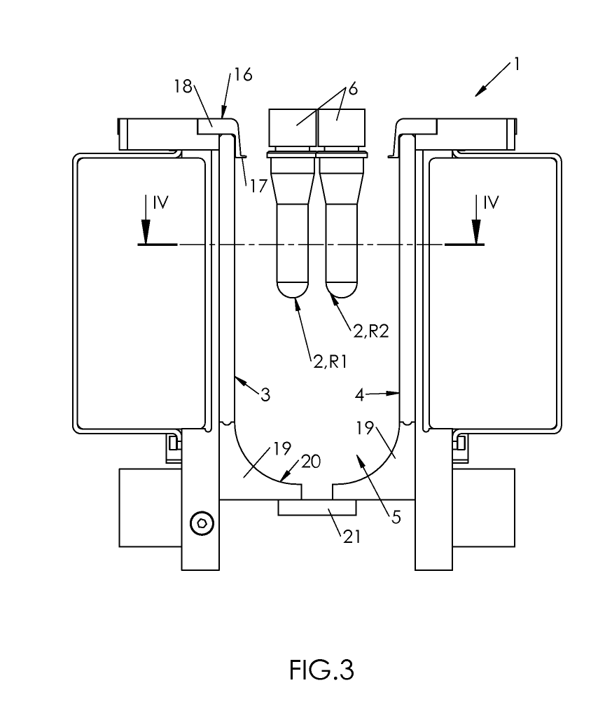

FIG. 3 is a side view showing a unit for heat treating preforms according to a second embodiment;

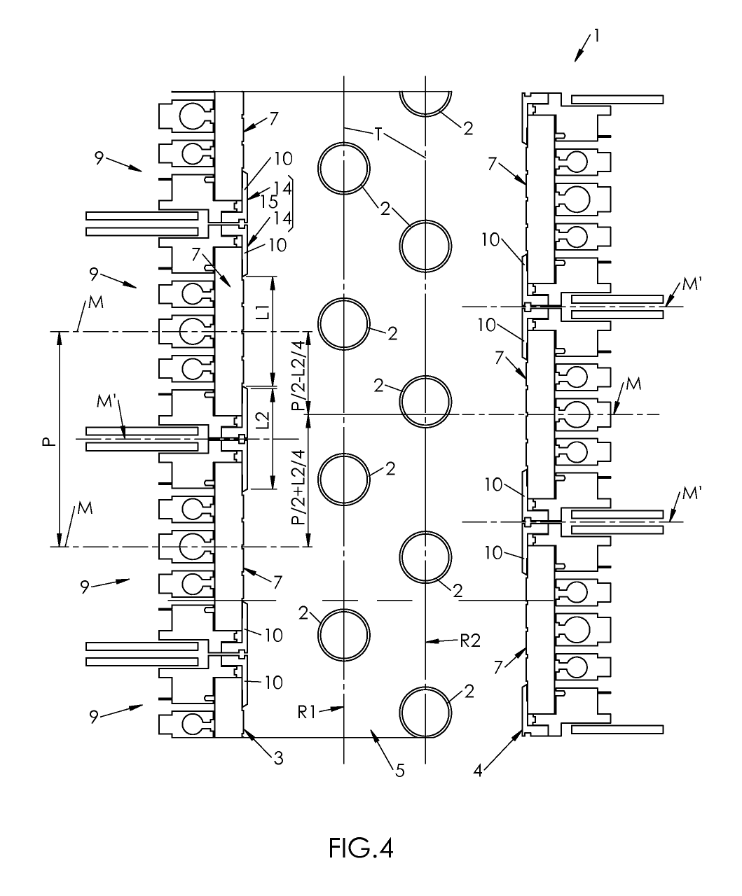

FIG. 4 is a view in horizontal cross-section of the heat treatment unit of FIG. 3, along the cutting plane IV-IV;

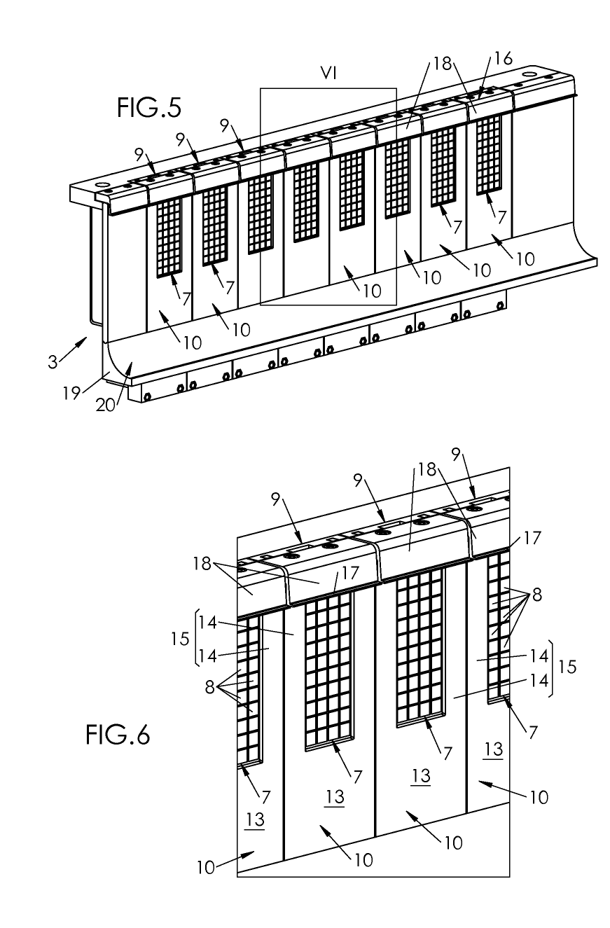

FIG. 5 is a view in perspective of a wall of a treatment unit as represented in the preceding figures;

FIG. 6 is a detailed view of the wall of FIG. 5, according to inset VI.

Represented schematically in the figures is a unit 1 for treating blanks 2 of containers moving in line. The blanks 2 in this instance are preforms, but could be intermediate containers having undergone temporary forming operations and intended to undergo one or more final operations in order to obtain final containers. Similarly, the processing in this instance is a heat treatment accomplished by radiation in the infrared range, but it could involve a decontamination process accomplished by ultraviolet radiation.

The preforms 2 are shown oriented neck upward, but they could be oriented neck downward.

As can be seen in the figures, the treatment unit 1 comprises two opposite walls, namely a first wall 3 and a second wall 4 facing the first one, which together define an enclosure 5 through which the preforms 2 travel in line along a predetermined trajectory T defining a longitudinal direction. In the illustrated example, said trajectory T is linear, but it could be (at least locally) curved, depending on the configuration of the locations in which the treatment unit 1 is installed.

The preforms 2 are attached to pivoting supports 6 called spinners (schematically represented by cylinders), which drive the preforms 2 in rotation around their principal axis so as to expose the body (i.e. the part beneath the neck) to the treatment.

According to a known embodiment, the spinners 6 are mounted on a chain driven so as to move along the trajectory T, and are each secured to a pinion that engages a fixed rack, so that each preform 2 is also driven in rotation around its axis of rotation as it moves along the trajectory T.

Any other means of driving the spinners in rotation can be employed. By way of example, this rotation can be motorized, for example by an individual motor for each spinner, or by means of a common motor, the rotation of which is transmitted to the spinners by an appropriate transmission, for example, by chain or by belt. Such motorization has the advantage of allowing a faster rotation of the preforms 2 inside the treatment unit 1, which can prove to be desirable given the compactness of the unit.

Each wall 3, 4 is both emitting and reflecting, and comprises a series of juxtaposed matrix emitters 7 each comprising a plurality of sources of electromagnetic radiation emitting monochromatically (or pseudo-monochromatically) in the infrared range. L1 denotes the longitudinal dimension (or width) of the emitter 7.

In theory, a monochromatic source is an ideal source emitting a sinusoidal wave of a single frequency. In other words, its frequency spectrum consists of a single line of zero spectral width (Dirac).

In practice, such a source does not exist, a real source being at best quasi-monochromatic, i.e. its frequency spectrum extends over a spectral bandwidth that is small but not zero, centered on a principal frequency where the intensity of the radiation is maximal. However, in common parlance, such a real source is called monochromatic. Moreover, a source emitting quasi- and monochromatically over a discrete spectrum comprising several narrow bands centered on different principal frequencies is called “pseudo-monochromatic.” It is also called multimode source.

In practice, the sources are organized by juxtaposition (i.e. some next to others longitudinally) and superposition (i.e. some above others) in order to form a matrix. For example, this involves laser sources, and preferably laser diodes. According to a preferred embodiment, each source is a vertical cavity surface emitting laser (VCSEL) diode, each diode emitting for example a laser beam having a rated unit capacity on the order of one mW at a wavelength situated in the short and medium infrared range—for example on the order of 1 μm.

In practice, the matrix is subdivided into subassemblies 8 of diodes which are represented in a simplified way in the form of tiles, each of which includes a substantially equal number of diodes.

The emitters 7 are juxtaposed (i.e. arranged side-by-side along the longitudinal direction), being spaced from each other, i.e. their lateral edges are not connected, since there is space between them.

Each emitter 7 defines a median plane M of vertical symmetry, and P denotes the interval (constant in the illustrated embodiment) between two adjacent emitters 7, defined as the distance between the median planes M of said emitters 7.

If, at the level of the preforms 2 each diode can be considered as a point source emitting a conical light beam, when all of the diodes are lighted, each emitter 7 produces a halo of infrared radiation that is difficult to represent because the optical phenomena are so complex, particularly the interference, and the numerous sources (several thousands per emitter).

In any event, the intensity of the radiation halo produced by each emitter has a maximum centered around the median axis and decreases with the distance therefrom, both horizontally and vertically.

Because the emitters 7 are longitudinally juxtaposed, it is obvious that the energy distribution of each wall 3, 4, is anisotropic at a given distance from the wall 3, 4, the intensity of the radiation being considered substantially constant in the longitudinal direction (while in practice, there are variations around an average intensity), whereas there are decreases on either side of the longitudinal ends of the walls 3 and 4.

In practice, as represented in FIG. 3, each emitter 7 is integrated into an individual heating module 9 which further comprises a slotted reflector 10 (suitable for reflecting the majority of the radiation from the emitters 7), framing the emitter 7 as well as a unit 11 for cooling the emitter 7, comprising ducts 12 for carrying and evacuating a heat exchange fluid.

The reflector 10, of rectangular contour, can be in the form of a mirror having, in a conventional way, a polished mirrored front face and a rear face coated with metallic silvering. Preferably, however, in order to avoid or minimize the phenomenon of loss of optical energy, the reflector 10 can be:
either specular, in the form of a plate made of metallic material and a front face of which, turned towards the interior of the enclosure, is polished, or of a material that is not necessarily metallic (for example a glass or a heat resistant plastic material) a front face of which is polished or coated with a thin highly reflective coating, for example metallic (particularly silver or gold),
or diffused, for example in the form of a plate made of highly reflective ceramic such as high-purity alumina.

Each reflector 10 has a lower section 13, substantially rectangular, which occupies the space beneath the emitter 7, surmounted by two upper sections 14 that laterally frame the emitter 7.

The heating modules 9 are juxtaposed in such a way that the reflectors 10 of two adjacent modules 9 are butted against each other, with no interstice between the reflectors 10, or with a minimal interstice that is just enough to allow for a possible expansion of the reflectors 10 when the heating unit 1 is in operation, depending on the thermal cycles undergone.

The upper sections 14 of two adjacent reflectors 10 together form a reflecting section 15 that extends into the space between two adjacent emitters 7, at the same level and height as the emitters. Preferably, each reflecting section 15 fills all of the space between the two adjacent emitters 7, the width of said section, denoted L2, being substantially equal to the distance between the lateral edges of the emitters 7. Because of the minimal value of any interstice that may be between two adjacent reflectors 10, the reflecting section 15 can be considered in a first approximation as continuous, the edge effects (i.e. the optical phenomena on the lateral edges of the reflectors 10) can be minimized. In a second approximation, however, the treatment unit 1 can be configured by taking the edge effects into account, as we will see below.

As can be seen in FIGS. 1, 3 and 4, each wall 3, 4 is surmounted by a limiter strip 16, which covers the emitters 7 to limit the propagation of radiation outside the enclosure 5.

As can be clearly seen in FIG. 1, the strip 16 has a protruding lip 17 that borders the emitters 7 and has a lower face which, turned towards the enclosure, is reflective in order to concentrate the radiation therein. In practice, as illustrated in FIGS. 3 and 4, the strip 16 is formed by juxtaposition of individual elements 18 that are integral with each heating module 9.

As can be seen in FIG. 2, the walls 3, 4 are arranged so that the emitters 7 and the reflective sections 15 are disposed in staggered fashion.

Indeed, the emitters 7 of the second wall 4 are longitudinally offset (i.e. along the trajectory T of the preforms 2) with respect to the emitters 7 of the first wall 3 so that the emitters 7 of each wall 3, 4 face a reflective section 15 of the opposite wall.

According to an embodiment illustrated in FIG. 2, in which the edge effects are ignored, said offset is equal to a half-interval, or P/2, so that the median plane M of each emitter 7 is coincident with the joint plane (denoted M′) between two successive reflectors 10 of the opposite wall.

This configuration can be adopted in the absence of discontinuity at the junction between the heating modules 9 or, at least when such a discontinuity is minimal. Indeed, a large discontinuity would lead to reflection defects of the radiation in the highest energy part of its spatial distribution (in the plane M).

In order to minimize such interstice (and thus the edge effects), the edges of adjacent reflectors 10 could be machined and abutted precisely. However, as was mentioned previously, the heating in the enclosure 5 can cause an expansion of the material, which necessitates the presence of such an interstice.

A first solution can consist of eliminating the edge effects by providing a single reflector 10 for two adjacent heating modules 9, which would straddle each of them between their respective emitters 7. In such a configuration, there is no longer any interstice between the adjacent modules 9 at the level of the reflectors.

Another solution, which preserves the individual realization of each module 9 equipped with a pair of reflectors 10 on either side of the emitter 7, consists of longitudinally offsetting the emitters 7 of the second wall 4 with respect to the emitters 7 of the first wall by a value such that the plane M (where the radiation concentration is maximal) is extended into the axis of a reflective portion free of discontinuity, and being for example coincident with a median plane M of a reflector 10. Such a solution is illustrated in FIG. 4, which shows an embodiment in which the median plane M of each emitter 7 is not coincident with the joint plane M′ between two successive reflectors 10, but is offset therefrom by a half-width of reflector, i.e. L2/4. In other words, the offset is equal to P/2±L2/4. Although this solution does not ignore the edge effects, it minimizes them.

Moreover, in order to avoid any possible shadow zone in the enclosure 5, the width L1 of the emitters is equal to or greater than the width L2 of the reflective section 15 facing it.

The heating unit 1 can comprise a lower reflector 19 having an upper reflective face 20, turned towards the enclosure 5. The reflector 19 is for example of the type described in patent application FR 2 954 920 (or its international equivalent WO 2011/083263), i.e. it has a flat reflective surface, which can be provided with holes placing the enclosure 5 in communication with a radiation trapping chamber.

According to an embodiment illustrated in the figures, the lower reflector 19 is concave (trough shaped) and extends between the walls 3, 4, which it connects in order to close the enclosure 5 and concentrate the radiation therein by limiting the dispersion thereof towards the exterior.

As can be seen in the figures, the reflector 19 can be produced in two parts, each of which is associated respectively with the walls 3, 4, so as to permit their separation (or coming together). In this case, in order to avoid any leak of radiation, it is preferable to position a subjacent secondary reflector 21 beneath a reflector 19, which fills the interstice between the two separated parts of the reflector 19. This arrangement makes it possible to adjust the width of the enclosure 5 to adapt to preforms 2 of different diameters, or to the travel of preforms 2 along multiple parallel lines, as illustrated in FIGS. 3 and 4.

In the embodiment illustrated in FIGS. 3 and 4, the preforms 2 travel in multiple (in this instance two) parallel lines R1, R2, along the same longitudinal direction, preferably in a staggered arrangement. The transverse separation between the lines R1, R2, and the longitudinal separation between the preforms 2 can be adjusted, particularly in accordance with the diameter of the preforms 2. The driving of the preforms 2 in two lines can be similar to that of the preforms 2 in a single line, the spinners simply being staggered over two parallel lines.

The face-to-face configuration of the two emitting walls 3, 4 is particularly appropriate to the travel of the staggered preforms 2 in at least two lines. Indeed, this configuration makes it possible to symmetrically heat the preforms 2 of the two lines, with a same spatial distribution of the radiation, and ultimately the same thermal profile on all of the preforms 2 at the exit of the treatment unit 1.

The configuration of the treatment unit 1 just described has the following advantages.

Firstly, the treatment unit 1 is compact as a result of the two emitting walls 3, 4 facing each other. For an equal number of emitters, the treatment unit 1 is about twice as compact as a treatment unit of equivalent power equipped with a single emitting wall.

Secondly, as a corollary to the compactness of the treatment unit 1, the treatment time of the preforms 2 is reduced, at an equal speed of travel.

Thirdly, as a result of the offsetting of the emitters of the walls 3, 4 facing each other, the radiation to which the preforms 2 is subject has small variations of the radiation (i.e. power of the radiation per transverse surface unit in the general direction of the radiation). The result is good heating homogeneity.

Fourthly, in the case of preforms 2 arranged in two parallel lines R1, R2, the production capacity of the treatment unit 1 is increased and its optical performance is increased as a result of a high rate of filling the enclosure 5.

1. Unit for treating blanks of hollow bodies made of plastic material, comprising an enclosure having two opposite walls, namely a first wall and a second wall facing the first one, which together define an enclosure through which the blanks pass along a predetermined longitudinal trajectory, wherein:
each wall includes a series of spaced emitters, each comprising a plurality of sources of monochromatic or pseudo-monochromatic electromagnetic radiation sources;
a reflective section extends into each space between two adjacent emitters;
the emitters of the second wall are offset longitudinally with respect to those of the first wall, so that the emitters of each wall face a reflective section of the opposite wall.

2. Treatment unit according to claim 1, characterized in that it comprises means of driving blanks in at least two parallel lines inside the enclosure.

3. Treatment unit according to claim 2, characterized in that it comprises means of driving blanks in two staggered parallel lines.

4. Treatment unit according to claim 1, characterized in that each emitter has a width substantially equal to or greater than that of the reflective section facing it.

5. Treatment unit according to claim 1, characterized in that each wall comprises a juxtaposition of individual modules, each of which comprises:
a matrix emitter,
a slotted reflector framing the emitter.

6. Treatment unit according to claim 5, characterized in that, for a given interval between two adjacent emitters, the emitters of the second wall are offset with respect to those of the first wall by a half-interval increased or decreased by a half-width of reflector.

7. Treatment unit according to claim 1, characterized in that, for a given interval between two adjacent emitters, the emitters of the second wall are offset with respect to the first wall by a half-interval.

8. Treatment unit according to claim 1, characterized in that the sources of radiation are lasers, for example VCSEL type laser diodes.
